(19) United States
(12) Patent Application Publication
(10) Pub. No.: US 2005/0011315 A1
(43) Pub. Date: Jan. 20, 2005

(54) Ratchet wrench

(76) Inventor: Terence Chen, Yi Lan Hsien (TW)

Correspondence Address: BIRCH STEWART KOLASCH & BIRCH, PO BOX 747, FALLS CHURCH, VA, 22040-0747, US

(21) Appl. No.: 10/648,205

(22) Filed: Aug. 27, 2003

(30) Foreign Application Priority Data
Jul. 18, 2003 (TW) 92119645

(51) Int. Cl. B25B 13/46

(52) U.S. Cl. 81/63.1

(57) ABSTRACT

A ratchet wrench includes a handle and an annular head from which the handle projects. The annular head defines a first space, a second space communicated with the first space and a third space communicated with the second space. An annular gear is rotationally put in the first space. The annular gear includes a toothed external face. A direction controller is put in the second space. The direction controller includes two pawls and a spring installed between the pawls. Each of the pawls includes a toothed face. The direction switch is rotationally mounted on the handle and partially put in the third space for bringing the toothed face of selective one of the pawls into engagement with the toothed external face of the annular gear.

### FIELD OF INVENTION

The present invention relates to a ratchet wrench.

### BACKGROUND OF INVENTION

Referring to FIGS. 7˜10, a conventional ratchet wrench 50 includes a handle 52 and an annular head 54 formed at an end of the handle 52. The annular head 52 defines a circular space 56, a crescent space 58 communicated with the circular space 56, a groove 60 in a side thereof and a recess 62 communicated with the groove.

A spring 64 and a ball detent 66 are put in the recess 62.

A direction switch 68 is put in and can be moved along the groove 60. A friction plate 70 is formed on the direction switch 68 for frictional contact with a user's finger. The direction switch 68 defines two recesses 72 and 74 in a side and a space 76 in an opposite side. The ball detent 66 is put in the recess 72 or 74 for keeping the direction switch 68 in one of two positions. The friction plate 70 defines an aperture 80 communicated with the space 76.

A V-shaped elastic element 80 includes two helical ends 82 and 84. The V-shaped elastic element 78 is put in the space 76.

As best shown in FIG. 8, a tab 86 is inserted in the space 76 for preventing the elastic element 80 from faltering in the space 76. The tab 86 defines an aperture 88.

A pin 90 is fit in the apertures 78 and 88 and put between the helical ends 82 and 84 so as to avoid the elastic element 80 escaping the space 76.

A pawl 92 includes two recesses 94 and 96 defined in a side and teeth 98 formed on an opposite side. The pawl 92 is put in the crescent space 58. The helical end 82 can be put in the recess 94, or the helical end 84 in the recess 96.

An annular gear 100 is put in the circular space 56. The annular gear 100 includes teeth 102 formed on an external side thereof for engagement with the teeth 98.

Referring to FIG. 9, the direction switch 68 is moved to a right-hand end of the groove 60 so that the ball detent 66 enters the recess 74. Via the elastic element 80, a right-hand end of the pawl 92 is moved to a right-hand end of the crescent space 58. Thus, the annular head 10 can drive the annular gear 100 clockwise, but not vice versa.

Referring to FIG. 10, the direction switch 68 is moved to a left-hand end of the groove 60 so that the ball detent 66 enters the recess 74. Via the elastic element 80, a left-hand end of the pawl 92 is moved to a left-hand end of the crescent space 58. Thus, the annular head 10 can drive the annular gear 100 counterclockwise, but not vice versa.

This conventional ratchet wrench 50 includes many elements. Many of its elements require fine fabrication, e.g., the direction switch 68 and the elastic element 80. It takes a lot of time to fabricate these elements. It also takes a lot time to assemble these elements. This conventional ratchet wrench 50 is very complicated in structure. As result, the cost of manufacturing of this conventional ratchet wrench 50 is high.

The present invention is therefore intended to obviate or at least alleviate the problems encountered in prior art.

### SUMMARY OF INVENTION

It is the primary objective of the present invention to provide a structurally simple ratchet wrench.

According to the present invention, a ratchet wrench includes a handle and an annular head from which the handle projects. The annular head defines a first space, a second space communicated with the first space and a third space communicated with the second space. An annular gear is rotationally put in the first space. The annular gear includes a toothed external face. A direction controller is put in the second space. The direction controller includes two pawls and a spring installed between the pawls. Each of the pawls includes a toothed face. The direction switch is rotationally mounted on the handle and partially put in the third space for bringing the toothed face of selective one of the pawls into engagement with the toothed external face of the annular gear.

Other objects, advantages and novel features of the invention will become more apparent from the following detailed description in conjunction with the attached drawings.

### BRIEF DESCRIPTION OF DRAWINGS

The present invention will be described via detailed illustration of the preferred embodiment referring to the drawings.

FIG. 1 is a perspective view of a ratchet wrench according to the preferred embodiment of the present invention.

FIG. 2 is an exploded view of the ratchet wrench of FIG. 1.

FIG. 3 is a cutaway view of the ratchet wrench of FIG. 1.

FIG. 4 is a cross-sectional view of the shown in FIG. 1.

FIG. 5 is a cross-sectional view of the ratchet wrench of FIG. 11 in a position for driving a bolt or nut counterclockwise.

FIG. 6 is similar to FIG. 5 but showing the ratchet wrench in a position for driving a bolt or nut clockwise.

FIG. 7 is an exploded view of a ratchet wrench according to prior art.

FIG. 8 is a cross-sectional view of the ratchet wrench of FIG. 7.

FIG. 9 is a cross-sectional view of the ratchet wrench of FIG. 7 in a position for driving a bolt or nut clockwise.

FIG. 10 is similar to FIG. 9 but showing the ratchet wrench in a position for driving a bolt or nut counterclockwise.

### DETAILED DESCRIPTION OF PREFERRED EMBODIMENT

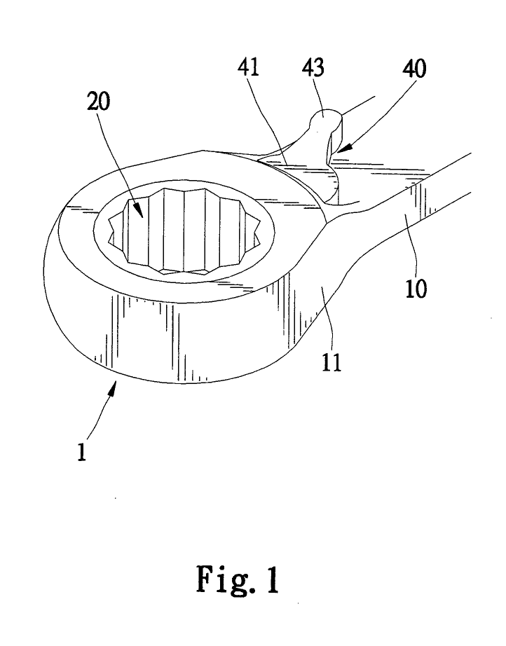

Referring to FIG. 1, according to the preferred embodiment of the present invention, a ratchet wrench 1 includes a handle 10 and an annular head 11 from which the handle 10 projects.

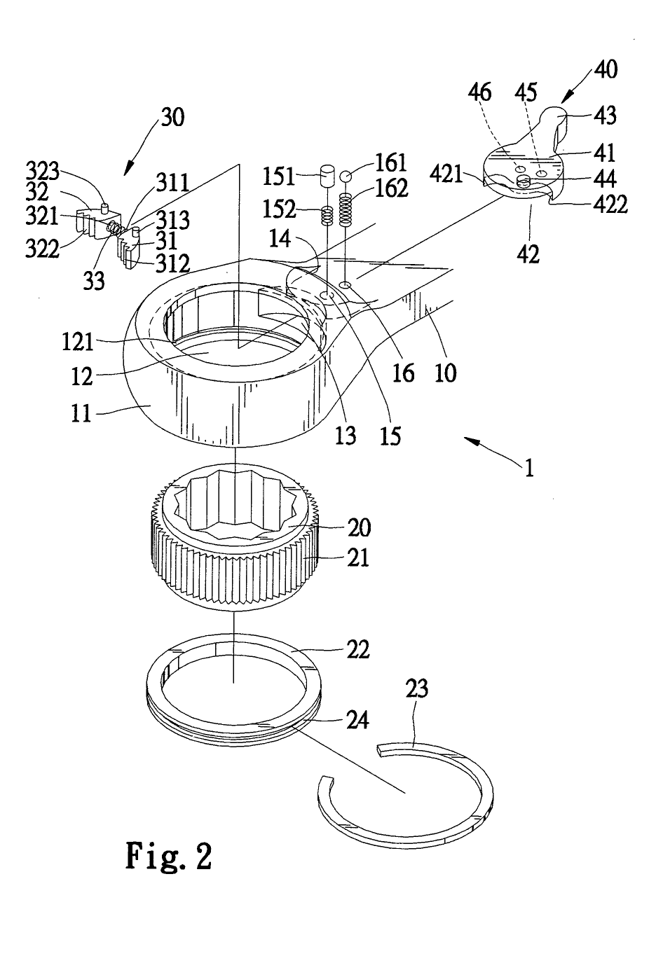

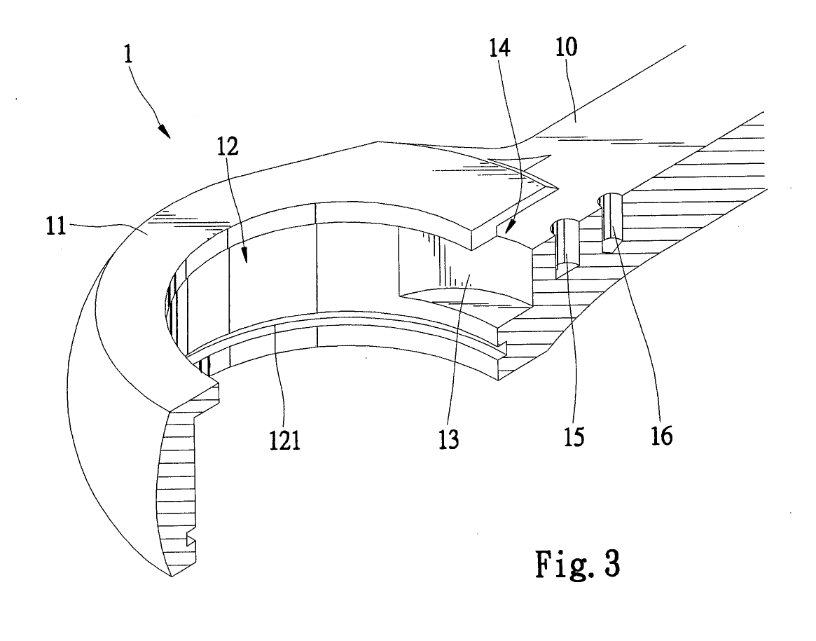

Referring to FIGS. 2 and 3, the annular head 11 defines a circular space 12, a crescent space 13 communicated with the circular space 12 and a semi-circular space 14 communicated with the crescent space 13. An annular groove 121 is defined in the wall of the circular space 12. Two recesses 15 and 16 are defined in the handle 10 near the semi-circular space 14.

A direction controller 30 is put in the crescent space 13. The direction controller 30 includes two pawls 31 and 32 and a spring 33 for connecting the pawl 31 with the pawl 32.

The pawl 31 includes a top, a bottom, a planar side, a toothed side 312, an arched side, a boss 311 formed on the planar side and rod 313 formed on the top.

The pawl 32 includes a top, a bottom, a planar side, a toothed side 322, an arched side, a boss 321 formed on the planar side and rod 323 formed on the top.

The spring 33 includes an end in which the boss 311 is fit and an opposite end in which the boss 321 is fit. Thus, the pawl 31 is firmly connected with the pawl 32 by means of the spring 33.

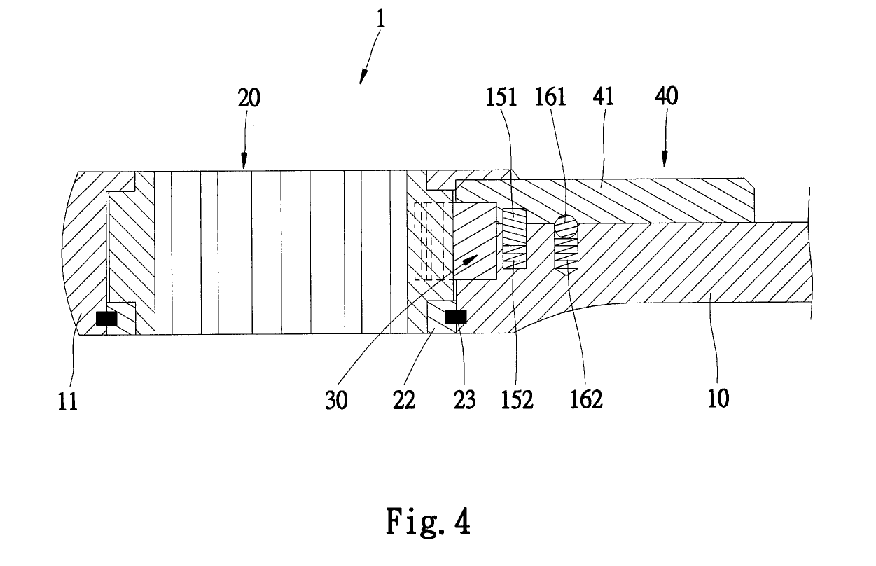

Referring to FIGS. 2 and 4, an O-ring 22 is put in the circular space 12. The O-ring 22 includes an annular groove 24 defined in an external face thereof.

A C-ring 23 includes an internal edge put in the annular groove 24 and an external edge put in the annular groove 121. Thus, the O-ring 22 is firmly attached to the annular head 11 by means of the C-ring 23.

An annular gear 20 is put in the circular space 12. The annular gear 20 is put on the O-ring 22 rotationally. The annular gear 20 includes a toothed internal face for engagement with a bolt or nut and a toothed external face 21 for selective engagement with the pawl 31 or 32.

A spring 152 and a rod detent 151 are put in the recess 15.

A spring 162 and a ball detent 162 are put in the recess 16.

A direction switch 40 includes a disc 41 and a lever 43 extending from the disc 41. The disc 41 includes a bottom in which a space 42, an aperture 44, two recesses 45 and 46 are defined. The wall of the space 42 includes a first end 421 and a second end 422. The disc 41 is put in the semi-circular space 14. The rod detent 151 extends into the aperture 44. Thus, the direction switch 40 is installed on the handle 10 and the annular head 11 rotationally. The ball detent 16 selectively enters the recess 45 or 46.

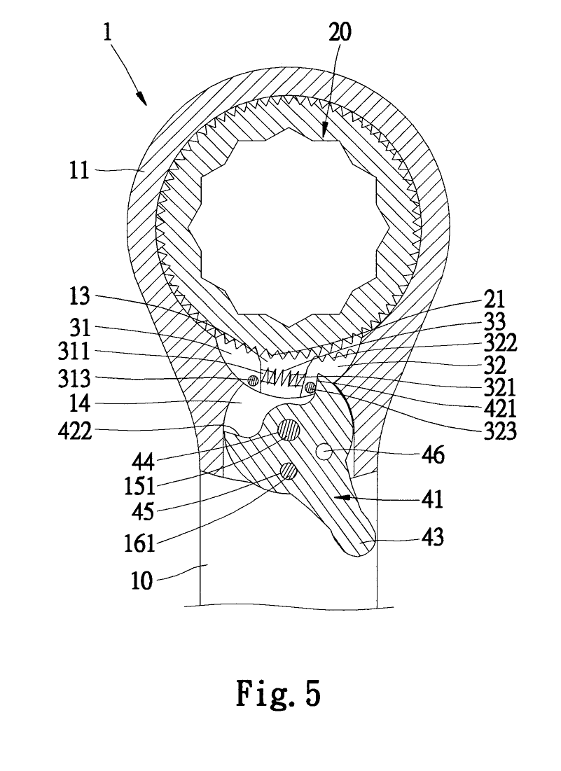

Referring to FIG. 5, the direction switch 40 is in a first position. The ball detent 16 enters the recess 46 so as to retain the direction switch 40 in the first position. The first end 421 of the wall of the space 42 pushes the rod 323. Thus, the pawl 31 is moved into a left-hand end of the crescent space 13. Thus, the annular head 11 can drive the annular gear 20 counterclockwise, but not vice versa.

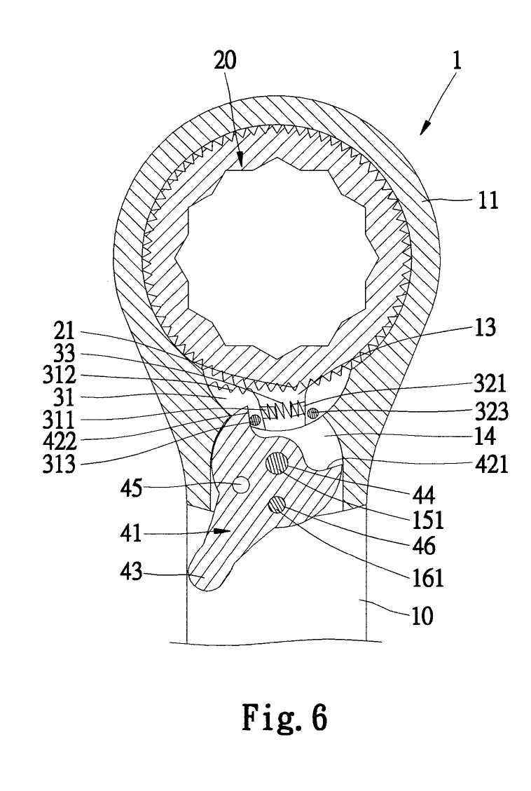

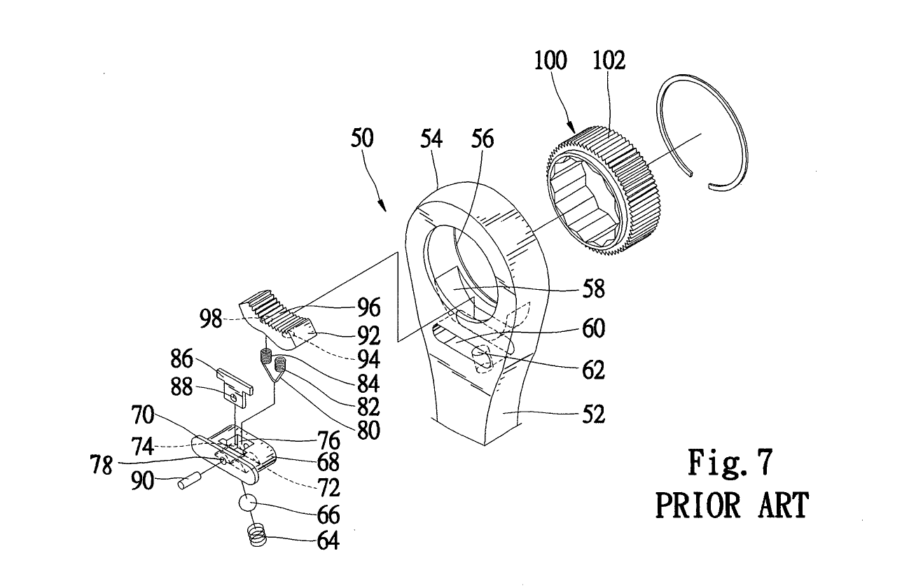

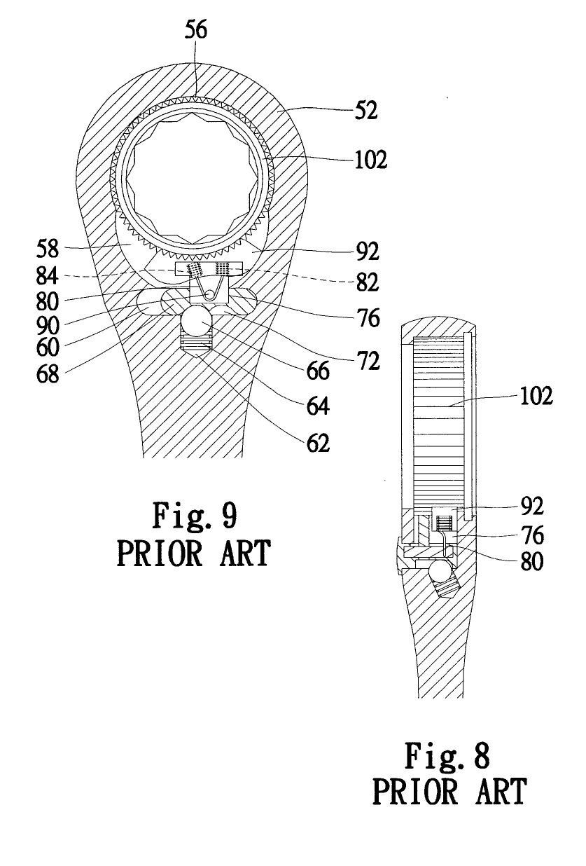

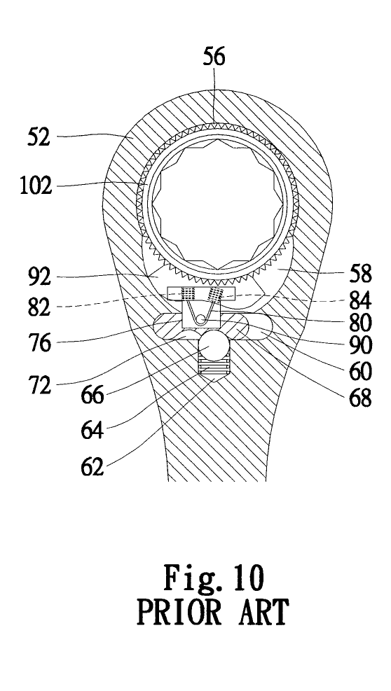

Referring to FIG. 6, the direction switch 40 is in a second position. The ball detent 16 enters the recess 46 so as to retain the direction switch 40 in the second position. The second end 422 of the wall of the space 42 pushes the rod 323. Thus, the pawl 32 is moved into a right-hand end of the crescent space 13. Thus, the annular head 11 can drive the annular gear 20 clockwise, but not vice versa.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. A ratchet wrench including:
a handle;
an annular head from which the handle projects, the annular head defines a first space, a second space communicated with the first space and a third space communicated with the second space;
an annular gear rotationally put in the first space, the annular gear including a toothed external face;
a direction controller put in the second space, the direction controller including two pawls and a spring installed between the pawls, each of the pawls including a toothed face; and
a direction switch rotationally mounted on the handle and partially put in the third space for bringing the toothed face of selective one of the pawls into engagement with the toothed external face of the annular gear.

2. The ratchet wrench according to claim 1 wherein the first space is a circular space.

3. The ratchet wrench according to claim 1 wherein the second space is a crescent space.

4. The ratchet wrench according to claim 1 wherein the third space is a semi-circular space.

5. The ratchet wrench according to claim 1 including a spring-biased detent, wherein the handle defines a recess for receiving the spring-biased detent, and the disc defines a recess for receiving the spring-biased detent so that the disc is rotationally mounted on the handle.

6. The ratchet wrench according to claim 1 including a spring-biased detent, wherein the handle defines a recess for receiving the spring-biased detent, and the disc defines two recesses selective one of which receives the spring-biased detent so that the disc is retained in selective one of two positions.

7. The ratchet wrench according to claim 1 wherein the direction switch includes a disc rotationally mounted on the handle and partially put in the third space for moving selective one of the pawls into engagement with the annular gear.

8. The ratchet wrench according to claim 7 wherein each of the pawls includes a rod, and the disc defines a space by means of a wall including two ends selective one of which can be engaged with one of the rods so as to engage the toothed face of one of the pawls with the toothed face of the annular gear.

9. The ratchet wrench according to claim 7 wherein the direction switch includes a lever extending from the disc.

10. The ratchet wrench according to claim 1 wherein each of the pawls includes a boss formed thereon and fit in an end of the spring so that it is firmly connected with the spring.

11. The ratchet wrench according to claim 1 including an O-ring fit in the first space for supporting the annular gear.

12. The ratchet wrench according to claim 10 including a C-ring, wherein the annular head defines an annular groove in an internal side for receiving an external edge of the C-ring, and the O-ring defines an annular groove in an external side for receiving an internal edge of the C-ring.
